(19) United States
(12) Patent Application Publication
(10) Pub. No.: US 2022/0087120 A1
(43) Pub. Date: Mar. 24, 2022

(54) Systems and Methods for Plant Growing Environment

(71) Applicant: Waveseer, LLC, Chicago, IL (US)

(72) Inventor: Robert Singer, North Palm Beach, FL (US)

(73) Assignee: Waveseer, LLC, Chicago, IL (US)

(21) Appl. No.: 17/271,706

(22) PCT Filed: Sep. 10, 2019
(86) PCT No.: PCT/US2019/050300

§ 371 Date: Feb. 26, 2021

Related U.S. Application Data
(60) Provisional application No. 62/733,877, filed on Sep. 20, 2018.

(51) Int. Cl. A01G 31/00

(52) U.S. Cl. CPC A01G 31/00; A01G 2031/006

(57) ABSTRACT

A system for growing plants includes a water circulation system connecting a plurality of deep water culture tanks in series and/or in parallel through which water is provided to plants housed in the tanks; a nanobubble generator for oxygenating the water; and a water cooling and disinfecting apparatus.

This application is a PCT international application that claims priority to U.S. Ser. No. 62/733,877 filed on 20 Sep. 2018 in the U.S. Patent and Trademark Office, the entirety of which is incorporated herein by reference.

### FIELD OF INVENTION

The present invention is directed to systems and methods for a plant growing environment that monitor and control both climate factors and hydroponic factors for optimum plant growth. The growing environment may be a module or smart room, in which the monitoring and controlling of one or more climate factors and/or one or more hydroponic factors may be via network, such as a wireless network or the internet. In particular, the present invention is directed to systems and methods for growing cannabis or hemp.

### SUMMARY OF INVENTION

The invention provides in a first embodiment a system for growing plants including a water circulation system connecting a plurality of deep water culture tanks in series and/or in parallel through which water is provided to plants housed in the tanks; a nanobubble generator for oxygenating the water; and a water cooling and disinfecting apparatus.

The invention provides in a second embodiment further to any of the previous embodiments a system wherein a water cooling and disinfecting apparatus is characterized by a plurality of coils through which a chilled liquid is circulated; an inlet for heated oxygenated water from the nanobubble generator; a passageway through which cooled oxygenated water is directed; and at least one UV light that provides UV light to the cooled oxygenated water.

The invention provides in a third embodiment further to any of the previous embodiments a system wherein the passageway of the water cooling and disinfecting apparatus has an electropolished surface or a mirrored surface.

The invention provides in a fourth embodiment further to any of the previous embodiments a system further characterized by at least one pH sensor to monitor pH of the water in the water circulation system; at least one electroconductivity sensor to monitor nutrient level in the water; and at least one sensor to monitor dissolved oxygen in the water.

The invention provides in a fifth embodiment further to any of the previous embodiments a system further characterized by a grow light support system comprising a moveable support frame having a plurality of lights; at least one carbon dioxide injection system; at least one CO₂ sensor; and at least one of a temperature sensor or humidity sensor.

The invention provides in a sixth embodiment further to any of the previous embodiments a system further characterized by a heating, ventilation, and air conditioning (HVAC) system.

The invention provides a plant growing environment characterized by a module or room comprising a system for growing plants further to any of the previous embodiments; a grow light support system comprising a moveable support frame having a plurality of lights and at least one carbon dioxide injection system; and a wireless network for providing hydroponic variables and climate variables monitored in the module to a device.

The invention provides in a first method embodiment a method for growing plants in a system having a water circulation system connecting a plurality of deep water culture tanks in series and/or in parallel through which water is provided to plants housed in said tanks; a nanobubble generator for oxygenating the water; and a water cooling and disinfecting apparatus, said method characterized by oxygenating water in the water circulation system with oxygen nanobubbles from the nanobubble generator; cooling and disinfecting the oxygenated water; and providing the cooled and disinfected oxygenated water to the plurality of deep water culture tanks housing plants.

The invention provides in a second method embodiment further to any of the previous method embodiments a method characterized by cooling oxygenated water by a plurality of coils through which a chilled liquid is circulated; directing the cooled oxygenated water through a passageway having an electropolished or mirrored surface; and exposing the cooled water to UV light, thereby disinfecting the cooled water.

The invention provides in a third method embodiment further to any of the previous method embodiments a method characterized by adding nutrients for the plants to the water before or after said oxygenating.

The invention provides in a fourth method embodiment further to any of the previous method embodiments a method characterized by replacing a water volume in the plurality of deep water culture tanks every 5 to 12 days.

The invention provides in a fifth method embodiment further to any of the previous method embodiments a method characterized by monitoring a level of oxygen in the water and electrical conductivity of the water.

The invention provides in a sixth method embodiment further to any of the previous method embodiments a method characterized in that the plants comprise cannabis or hemp.

The invention provides a water cooling and disinfecting apparatus for use in the systems and/or methods according to any of the previous embodiments characterized by a plurality of coils through which a chilled liquid is circulated; an inlet for oxygenated water, configured such that said oxygenated water contacts said plurality of coils; a passageway having an electropolished or mirrored surface through which the oxygenated water is directed; at least one UV light that provides UV light to the oxygenated water, thereby disinfecting the oxygenated water; and an outlet for the oxygenated water.

An advantage of the system of the present invention is that by using nanobubbles to oxygenate water, UV disinfection of the water is increased.

Another advantage of the system of the present invention is that by using nanobubbles to oxygenate water, nutrient uptake of the plants is increased and nutrient waste is reduced.

Another advantage of the system of the present invention is that by using nanobubbles to oxygenate water, the size and mass of plants is increased.

Yet another advantage of the present invention is it provides for recycling of water, thereby saving a substantial amount of water as compared to soil-based plant growing systems.

Still another advantage of the present invention is that the system may be configured as a smart room with a plurality of individually-controlled zones.

Another advantage of the present invention is that the system may be configured as a module, thereby allowing a plurality of self-contained and individually-controlled modules to be housed in a single building or container.

### BRIEF DESCRIPTION OF THE DRAWINGS

FIG. 1A shows a perspective view of a growing environment module/smart room according to an embodiment of the present invention.

FIG. 1B shows a top view of a growing environment module/smart room having five zones according to an embodiment of the present invention.

FIG. 2 shows a schematic process flow diagram of a hydroponic control system according to an embodiment of the present invention.

FIG. 3 shows a schematic of a deep water culture module for a water irrigation and circulation system according to an embodiment of the present invention.

FIG. 4 shows a schematic diagram of hydroponic control system according to an embodiment of the present invention.

FIG. 5 shows a schematic diagram of a water disinfection/conditioning system according to the present invention.

FIG. 6 shows a perspective view of a growing environment module/smart room with a climate control system according to an embodiment of the present invention.

FIG. 7 shows a grow light support system according to an embodiment of the present invention.

FIG. 8 shows a perspective, cut-away view of a growing environment module/smart room according to an embodiment of the present invention.

FIG. 9 shows a perspective, cut-away view of a growing environment module/smart room with a climate control system according to an embodiment of the present invention.

### DETAILED DESCRIPTION OF INVENTION

In this detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

As used herein “substantially”, “generally”, “about”, and other words of degree are relative modifiers intended to indicate permissible variation from the characteristic so modified (e.g., ±0.1%, ±0.5%, ±1.0%, ±2%, ±5%, ±10%, ±20%). It is not intended to be limited to the absolute value or characteristic which it modifies but rather possessing more of the physical or functional characteristic than its opposite, and preferably, approaching or approximating such a physical or functional characteristic.

The present invention is directed to systems and methods for a plant growing environment that monitor and control both climate factors and hydroponic factors for optimum plant growth. In particular, the present invention is directed to systems and methods for growing cannabis or hemp. Hemp may be defined as the plant cannabis and any part of the plant, with a delta-9 tetrahydrocannbinol [THC] concentration of not more than 0.3 percent on a dry weight basis. However, it will be readily understood that the systems and methods of the present invention could apply to other plants (e.g., soybeans, tomatoes, strawberries, beets, onions, and the like).

### I. OVERVIEW OF PLANT GROWING ENVIRONMENT

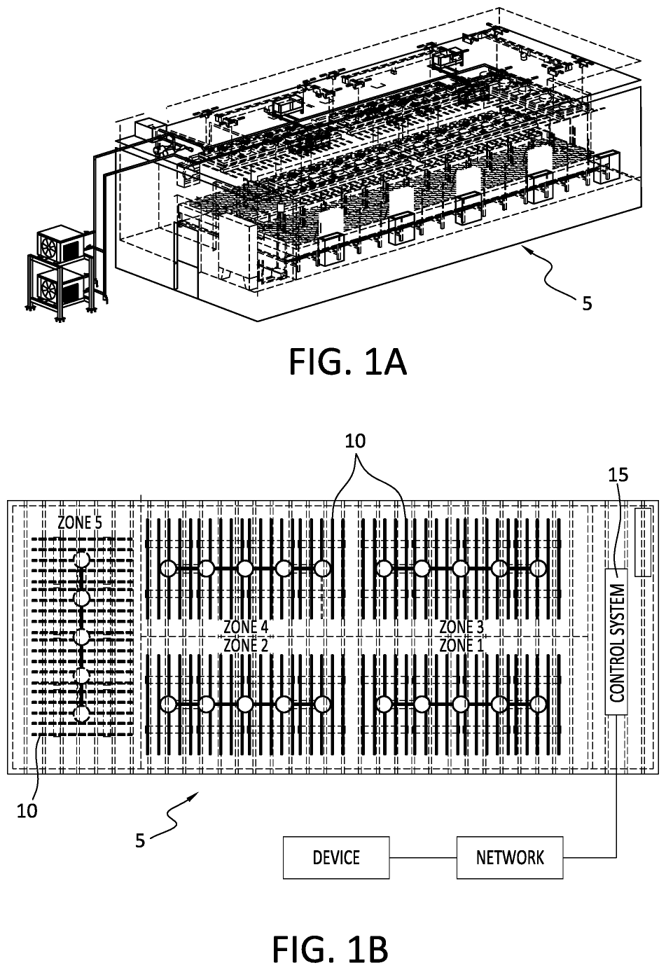

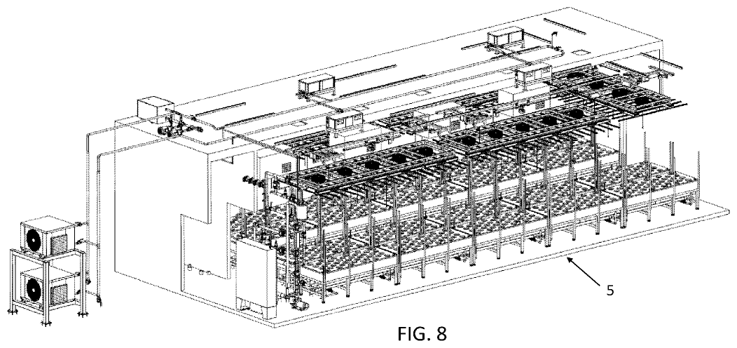

According to a specific embodiment of the present invention, the plant growing environment may be configured as a room 5, as shown in FIG. 1A and FIG. 8. In a specific embodiment, the room may be configured to be about 20 feet wide, about 50 feet long, and about 12 feet high (about 6.1 m wide, about 15.25 m long, and about 3.7 m high). Accordingly, the room may be configured as a module that can be a stand-alone, completely-independent growing environment for flower production (FIG. 1A). In addition, the room/module can be combined with other rooms/modules and easily housed in a variety of building structures or warehouses. Due to the modular design capabilities, each room may be independent of the other rooms. This feature assures a clean sterile environment that is scalable and energy efficient.

According to the present invention, the growing environment/room 5 may have one or more zones 10 (e.g., five zones), as shown in FIG. 1B, with climate and hydroponic variables being monitored and controlled for each zone.

Climate variables include, but are not limited to, air temperature, humidity, carbon dioxide, and light. Hydroponic variables include, but are not limited to, water pH, nutrient level (electroconductivity), water temperature, and water oxygenation. The present invention allows for monitoring and control of such variables for optimum plant health. In a specific embodiment, the climate and hydroponic variables are monitored and optimized continuously and in real-time. All monitored data is logged and archived for quality control and repeatability.

In specific embodiments, the climate and hydroponic variables may be monitored, controlled, viewed, and archived by a control system 15 (FIG. 1B) located inside or outside of the growing environment or room. The control system is electrically connected to various sensors, systems, and apparatus in the growing environment and, in specific embodiments, may include at least one of a control panel having a display; a database to record and log data; or notification controls. Electrically connected means through a direct electrical connection, through an indirect electrical connection via other devices and connections, and may include being in communication with.

Alternatively, or in addition, the climate and hydroponic variables may be viewed, monitored, and controlled by a device electrically connected to the control system via a network (e.g., a wireless network, the internet, etc.). In specific embodiments, the device may be an electronic or digital device including, but not limited to, a desktop computer, a laptop computer, a tablet computer, a smartphone, a wearable device (e.g., watch, band), any smart device, computer, tablet or phone having wireless access to the Internet, and the like. In a specific embodiment, access to and control of the climate and hydroponic variables of the growing environment may be provided via a downloadable app. The climate and hydroponic variables are logged and recorded, thereby allowing a complete history of the plant growing environment/room, and indeed specific plants, to be available via the control system and/or device.

### II. HYDROPONIC CONTROL SYSTEM

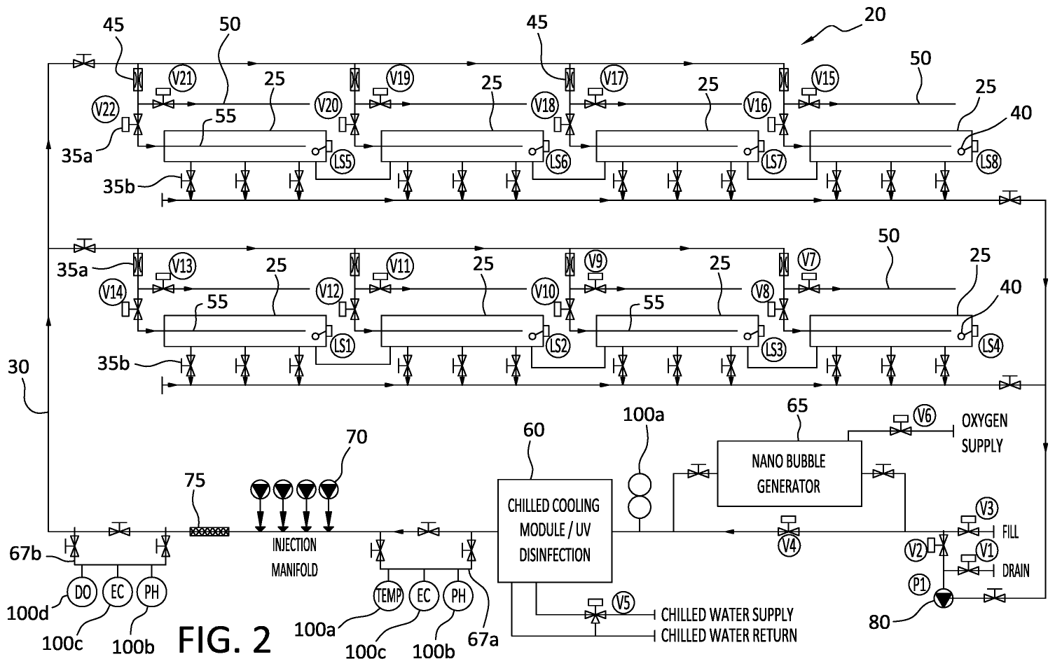

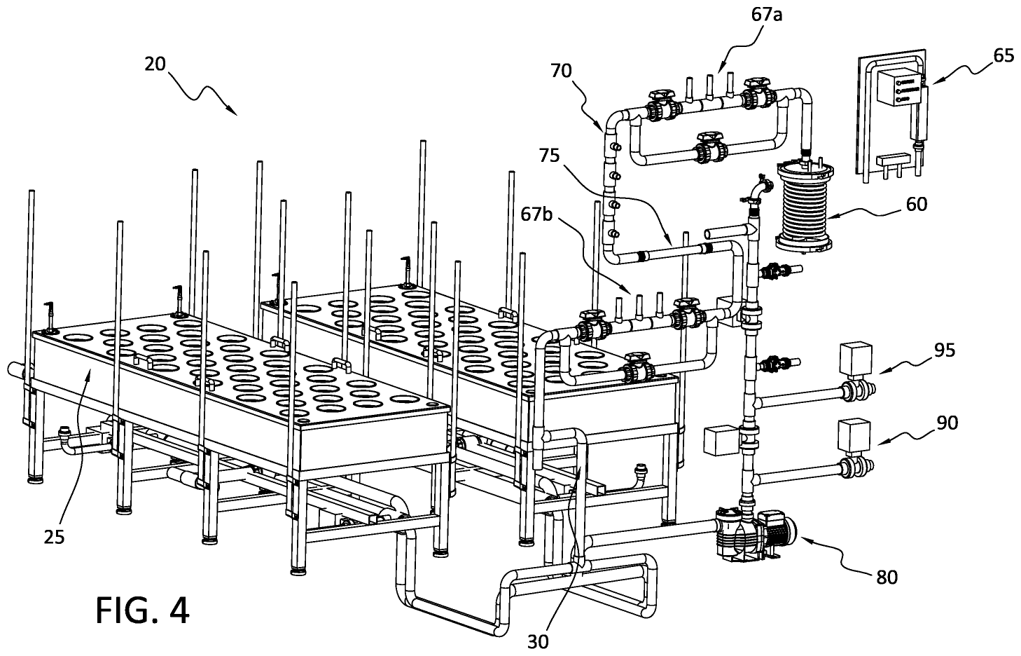

According to the present invention, the hydroponic variables within one or more zones 10 of the plant growing environment/room 5 may be monitored by and controlled in a hydroponic control system 20, an embodiment of which is shown in the exemplary, non-limiting schematic process flow diagram of FIG. 2 and in FIG. 4.

As discussed above, the growing environment/room may comprise one or more zones 10. Each zone comprises one or more deep water culture (DWC) tanks 25. A DWC tank 25 holds plant roots suspended in water containing nutrients for plants. In embodiments, no soil is used. The DWC tanks may be of any desired size and may have grow containers or cubes for the plants. In a specific embodiment, each DWC tank may hold about 100 gallons (380 L) of water.

As shown in FIG. 2, a plurality of DWC tanks 25 may be connected in series and/or parallel that are fed by a water irrigation and circulation system 30 through which water containing nutrients for the plants flows. Each DWC tank 25 or a group of DWC tanks may have one or more fill and drain valves (e.g., 35a, 35b, respectively) as well as a sensor 40 for monitoring water levels. An alert or notification may be provided to the control system 15 and/or device when the water level is below or above a preset water level.

The water containing nutrients is recirculated through the water irrigation and circulation 30 system substantially continuously. In embodiments, the water irrigation and circulation system 30 may allow replacement of a water volume in a plurality of DWC tanks every five to twelve days.

The water irrigation and circulation system 30 allows for two methods of providing water to the plants in the DWC tanks 25, for example, via a manifold and flow regulator 45: 1) a top drip method 50 in which water is fed above the plants and/or 2) a bottom method 55 in which water is fed directly to the DWC tanks 25. In specific embodiments, one or more valves may be installed on each DWC tank or group of DWC tanks to control the water feed method desired. In embodiments, it is possible to switch back and forth between a top drip method or bottom method as desired.

The hydroponic control system 20 includes a water cooling/disinfection module 60, a nanobubble dissolved oxygen module 65; at least one sensor (e.g., a plurality of sensors or sensor bank to monitor various hydroponic variables, both pre-dosing of nutrients 67a and post-dosing of nutrients 67b); at least one of a nutrient dosing pump or pH adjusting pump 70 for adding nutrients into or adjusting the pH of the water; at least one static mixer 75 to blend and mix the water/nutrient solution; and at least one pump 80 (e.g., water recirculation pump). Several of these features are discussed in more detail below.

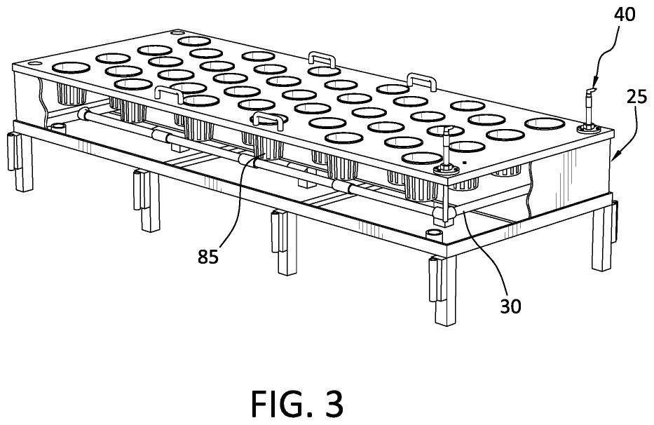

An embodiment of a DWC tank system is shown in FIG. 3. The DWC tank system includes a DWC tank 25; a stand; a water level sensor 40, and a plurality of plant pots 85. A portion of the water irrigation and circulation system 30 is also shown.

An exemplary, non-limiting embodiment of a hydroponic control system 20 is shown in FIG. 4. The hydroponic control system includes a recirculation pump 80; a drain outlet 90; a fresh water inlet 95; a nanobubble dissolved oxygen module 65; a water cooling/disinfection module 60; a pre-dosing sensor bank 67a; a plurality of dosing pumps 70; static mixer 75; a post-dosing sensor bank 67b; and a return to water irrigation and circulation system 30.

In embodiments, the water in the water irrigation and circulation system may be recycled and used again in the growing environment and/or for outdoor irrigation and property maintenance. By collecting and filtering the nutrient water, the system of the present invention allows substantial water savings. Additionally, any recaptured and unused nutrients may be filtered, dried, and either disposed of or sold.

For example, in a specific embodiment, one growing environment/room 5 may require about 114,400 gallons (433,050 L) of water per year for operation. This embodiment uses an initial fill of 2000 gallons (7570 L) for 5 zones, each zone having four DWC tanks. There is about 10% water loss due to evaporation. A total volume of 2000 gallons (7570 L) may be recycled each week. Thus, the net use per week of a growing environment/room is about 200 gallons (757 L) (the rest being recycled) and yearly net water usage per room is about 10,400 gallons (39,368 L). Traditional soil-based plant watering systems do not allow for recycle, as it is a one shot feed several times per day at about 1.25 gallon (4.7 L) per day per plant. In one year, traditional soil-based watering procedures use about 354,900 gallons (1,343,438 L), none of which is recoverable or recycled.

### III. HYDROPONIC VARIABLES

The following discussion of hydroponic variables may be read in conjunction with the above discussion of the hydroponic control system and FIGS. 2-4.

A. Water Temperature

The temperature of the water in the water irrigation and circulation system 30 may be monitored by one or more temperature sensors 100a. The water temperature may be controlled by a water cooling/disinfection module 60. In embodiments, the water cooling/disinfection module 60 comprises a heat exchanger to remove heat from the water irrigation and circulation system and to maintain the water temperature within a desired range. In specific embodiments, the water may be maintained at a temperature range of about 65 to 68° F. (18.3 to 20° C.) in order to lessen or prevent bacteria and fungus in the nutrient water, as well as help prevent root rot of the plants in the DWC tanks 25.

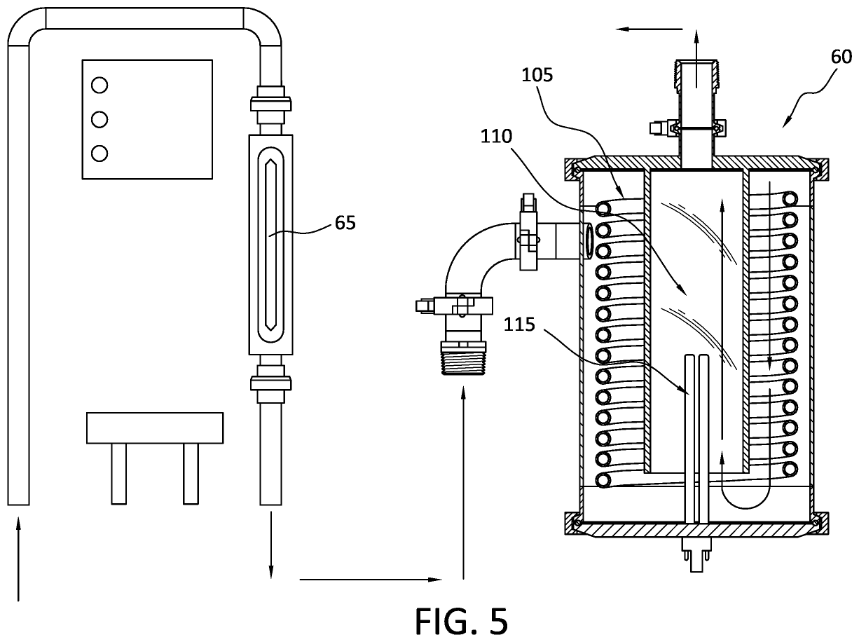

In embodiments, the water cooling/disinfection module 60 may include a UV disinfectant apparatus comprising one or more UV lights or bulbs that apply ultraviolet light to the water. A combined water cooling/disinfection module 60 is shown in FIG. 5 and will be discussed in more detail below.

B. Water pH

In embodiments, the pH of the water in the water irrigation and circulation system may be monitored by at least one pH sensor, for example a sensor 100b included within sensor banks 67a, 67b. In specific embodiments adjustments to pH may be made by one or more acid/base injection pumps in pump bank 70 that adjust the pH of the water up or down. In specific embodiments, the pH of the water may be maintained at a range of about 5 to 8.

C. Nutrient Level

An indication of the nutrient level in the water of the water irrigation and circulation system 30 may be determined by monitoring the electroconductivity (EC) of the water (the equivalent of total dissolved solids or nutrient concentration). The EC may be monitored by at least one EC sensor, for example a sensor 100c included within sensor banks 67a, 67b. In specific embodiments, adjustments to EC may be made by one or more nutrient dosing pumps 70 that adjust the content of the nutrients in the water to account for nutrients used by the plants.

D. Dissolved Oxygen

According to the present invention, dissolved oxygen (DO) is introduced into the water irrigation and circulation system 30. In a specific embodiment, oxygen nanobubbles are introduced into the water by a nanobubble dissolved oxygen module 65. The nanobubble generator allows oxygen (or any other desired gas, such as ozone, nitrogen, or carbon dioxide) to be introduced into the water as nanobubbles. In specific embodiments, the nanobubbles may have a bubble diameter of about 100 nm to about 10,000 nm.

The oxygen nanobubbles have several effects. First, the oxygen nanobubbles provide a large surface area per volume, so that when the oxygenated water is subjected to ultraviolet light, disinfection of the water is increased due to a prism/UV light-scattering effect. Second, the oxygen nanobubbles attach to the roots of the plants in the DWC tanks, thereby increasing the uptake of nutrients in the water and reducing nutrient waste. Third, the dissolved oxygen nanobubbles increase the size and mass of the plants.

A water cooling/disinfection module 60 is shown in FIG. 5. Heated nutrient water with oxygen-enriched nanobubbles from nanobubble generator 65 is fed via an inlet to a water cooling/disinfection module 60 comprising a housing, a heat exchanger, and at least one UV light. The heated, oxygenated nutrient water flows around a plurality of cooling coils 105, which is a heat exchanger, until the cooled, oxygenated water reaches a bottom of the module. In a specific embodiment, cooled water or liquid for the plurality of coils in the heat exchanger may be obtained from an HVAC system (e.g., as discussed below), thereby saving the energy required for a growing environment/room.

The cooled, oxygenated water turns (e.g., 180 degrees) and travels up and out of a top of the cooling/disinfection module. The oxygenated water moves upwards through a central internal passageway/cylinder 110 that, in specific embodiments, may have an electropolished surface (e.g., a metal surface, stainless steel, or the like) or a mirrored surface. An internal UV bulb or bulbs 115 located at or near the bottom of the module expose the water to UV light, which is scattered in near infinite directions for optimum disinfection of the water. This UV light scattering is due to the prism effect of the nanobubbles and their large surface area. In a specific embodiment, a nanobubble generator module may include both a nanobubble generator 65 and a water cooling/disinfection unit 60.

At least one sensor monitors dissolved oxygen (and/or other gas) levels in the water, for example, a DO sensor 100d included within sensor bank 67b. Adjustments may be made controlled to a desired set point or range. In specific embodiments, the DO level of the water is maintained at a range of about 15 to 25 mg/L.

### IV. CLIMATE CONTROL SYSTEM

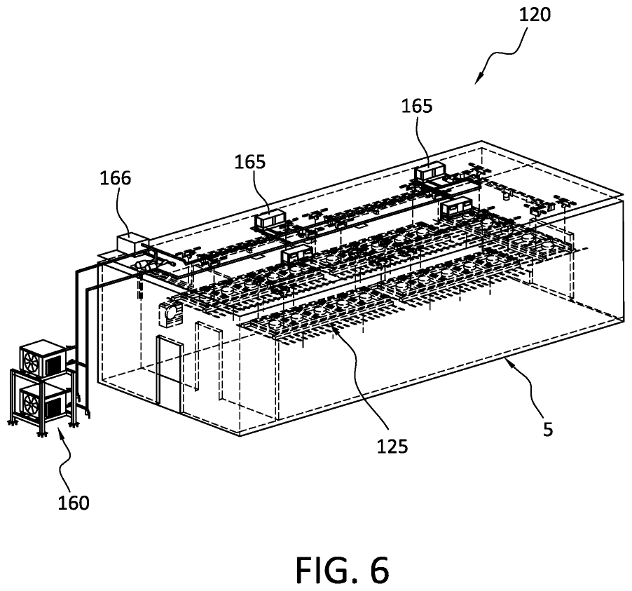

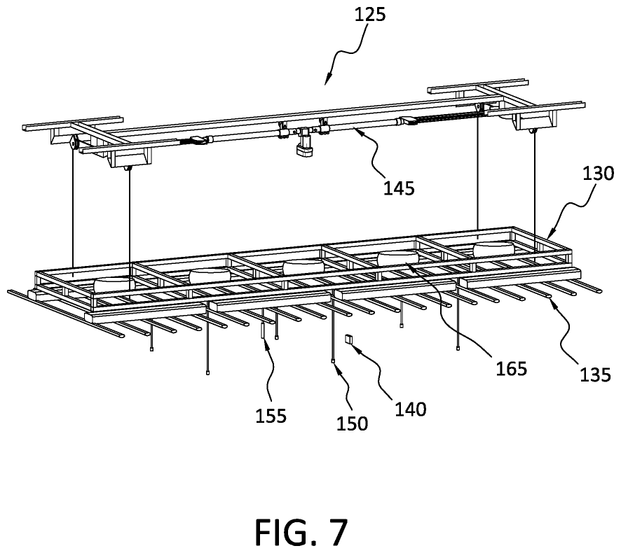

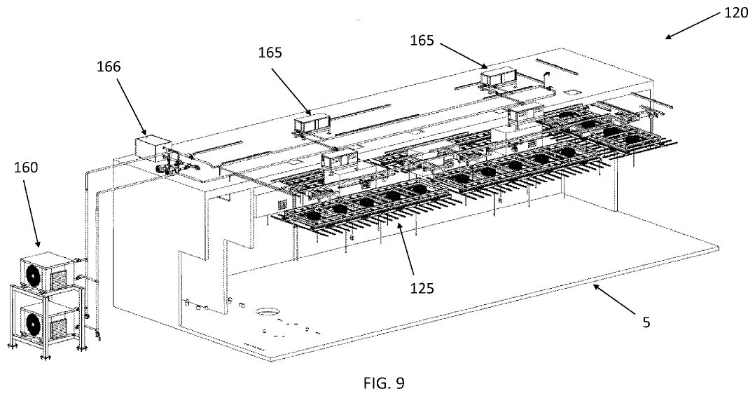

According to the present invention, the climate variables within one or more zones 10 of the plant growing environment/room 5 may be monitored by and controlled in a climate control system 120, as shown in FIG. 6 and FIG. 9. In particular, the climate control system 120 includes a grow light support system 125 installed or placed above the plants (above or at the top of the plant canopy), which is shown in more detail in FIG. 7.

According to the present invention, the climate control system may also include an HVAC system, a carbon dioxide injection system, at least one temperature sensor, at least one humidifier and at least one dehumidifier. Several of these features are discussed in more detail below.

### V. CLIMATE VARIABLES

The following discussion of climate variables may be read in conjunction with the above discussion of the climate control system and FIGS. 6-7.

A. Light

In embodiments, the grow light support system 125 comprises a support frame 130 that supports or houses a plurality of lights 135 (any desired grow lights, including but not limited to, LED, fluorescent lights, halogen lights, high pressure sodium, and the like) as shown in FIG. 7. The support frame 130 includes one or more light sensors 140 that monitor light intensity levels and duration of light. In embodiments, the one or more light sensors may be on an adjustable cable attached to the support frame, thereby allowing the one or more light sensors to be placed at the level of the plant canopy or within the canopy. The plurality of lights 135 may be controlled by on/off timer functions, for example, by control system 15. In specific embodiments, there is no exposure of the plants to outdoor or natural light.

A support frame 130 for each zone 10 or combination of zones may be independently raised and lowered by a height adjustment system 145 (e.g., by an actuator) to allow for height adjustment of the plurality of lights, for example, from a height from about 12 to about 70 inches (30.5 cm to 178 cm) above a DWC tank 25 or combination of DWC tanks. In a specific embodiment, each zone 10 (e.g., as shown in FIG. 1B) may have 4 DWC tanks and 8 LED lights.

B. Carbon Dioxide (CO₂)

According to the present invention, the support frame 130 may include a CO₂ injection system 150 having one or more CO₂ injection nozzles, which allows for dosing of carbon dioxide to the plant canopy. In embodiments, the CO₂ injection system 150 may be connected to a bottom of and hang down from the support frame 130. The CO₂ injection system may have one or more automated valves for precise control of CO₂ in each zone.

The grow light support frame 130 may also include at least one CO₂ sensor 155. In specific embodiments, the carbon dioxide level is monitored in each zone independently. In specific embodiments, the carbon dioxide may be maintained at a range of about 700-1200 ppm when the lights are on and a range of about 400-600 ppm when the lights are off. When lights are off, air and CO₂ are purged from the growing environment/room and fresh air is admitted by air handlers or fans.

In specific embodiments, the growing environment/room may have a safety control system to protect an operator from entering the growing environment/room during high CO₂ levels. The safety control system may include at least one of magnetic locks on doors, a warning light or beacon, or alarm notifications if access is not allowed due to a high CO₂ level.

C. Air Temperature

According to the present invention, the air temperature in the growing environment/room may be controlled by a heating, ventilation, and air conditioning (HVAC) system 160, as shown in FIG. 6. HVAC systems that may be used include, but are not limited to, central-type systems, split systems, geothermal systems, thermal batteries, liquid to liquid cooling, chillers with and without cooling towers, and general evaporative cooling. The HVAC systems can be filtered, for example, though HEPA and other types of filters like activated charcoal filters with ultraviolet (UV) lights or other method of air filtration.

In a specific embodiment, the HVAC system 160 comprises two 6 or 7 ton air cooled chillers in parallel and 2-4 air handlers or fans 165 for the growing environment/room. The air temperature may be controlled to a desired set point or range and may be monitored and/or adjusted by one or more temperature sensors 140 within each zone.

The one or more temperature sensors may be included on or housed in the support frame 130.

The HVAC system 160 may be located in the growing environment/room, along with air circulation handlers or fans or may be located outside of the room. In a particular embodiment as shown in FIG. 6, condenser coils of HVAC system 160 (e.g., 6-7 ton chillers) are located outside the growing environment/room because they generate heat. The fan coils may be on a roof of a growing environment/room or inside a structure housing a plurality of growing environments/rooms. The air in the growing environment is stratified, as cool air is drawn down the walls of the room, for example via ducts in the walls or diffusers. This configuration allows for greater efficiency, as heated air naturally rises towards the plant canopy.

In specific embodiments, the air temperature in the growing environment or each zone may be maintained at a range of about 74-78° F. (23-25.6° C.) when the lights are on and about 68-72° F. (20-22.5° C.) when the lights are off.

In a specific embodiment, the HVAC system may include a water holding tank 166 to keep an amount of water at a predetermined temperature, for example, at about 38-45° F. (3.3-7.2° C.). The water holding tank 166 acts as a heat sink and may provide water to the water cooling/disinfection module 60.

D. Humidity

The humidity of the growing environment/room may be controlled by at least one humidifier and/or at least one dehumidifier. In embodiments, the at least one humidifier and/or at least one dehumidifier may be located on the support frame 130 or may be suspended from the ceiling of the growing environment (e.g., along a ceiling center line). Alternatively, the at least one humidifier and/or at least one dehumidifier may be located on floor of the growing environment/room.

At least one humidity sensor may monitor humidity levels. In embodiments, the at least one humidity sensor may be combined with the temperature sensor 140 as a combined sensor. The at least one humidity sensor may be included on or housed in the support frame. In specific embodiments, the humidity may be maintained at about 50%-80% during a vegetation stage of the plants and at about 40%-50% during a flowering stage of the plants.

### VI. EXEMPLARY VARIABLES AND ALARM NOTIFICATION

The system according to the present invention allows an operator to enter specific set points or ranges for any one or all of the hydroponic and climate variables. In embodiments, if the variables fall outside of the specific set points or ranges, an alarm or alert may notify the operator, for example, via email, text, or control panel or device display. Exemplary, non-limiting, embodiments of such set points and alarm notifications are shown in the Table below.

Climate Systems

| Climate | | |
|---|---|---|
| Factor | Set Point | Alarm Notification |
| Air | Daylight (light on) - 74 F.-78 F. | High Temp - 85 F. |
| Temper- | Night (lights off) - 68 F.-72 F. | Low Temp - 60 F. |
| ature | | |
| Humidity | Vegetation - 50%-80% | High Humidity - 85% |
| | Flower - 40%-50% | Low Humidity - 35% |
| CO₂ | Daylight (lights on) - 1200 ppm | High CO₂ - 2000 ppm |
| | Night (lights off) - | Low CO₂ - 350 ppm |
| | 400-600 ppm | |
| Light | Vegetation cycle: | Light leak when night |
| | 18 hours on/6 hours off | Intensity limit is |
| | Flower cycle: | recorded |
| | 12 hours on/12 hours off | |

Hydroponic Systems

| Hydro- | | |
|---|---|---|
| ponic | | |
| Factor | Set Point | Alarm Notification |
| pH | 5.8-6.0 | High pH - 7.0 |
| | | Low pH - 5.0 |
| EC | Vegetation - 1.3 mS/cm | High EC - 1.75 mS/cm |
| (milli- | Flower - 2.2 mS/cm | Low EC - 1.0 mS/cm |
| Siemens/ | | |
| cm) | | |
| Water | Vegetation - 65 F. - 69 F. | High Water Temp - 80 F. |
| Temper- | Flower - 55 F.- 60 F. | Low Water Temp - 50 F. |
| ature | | |
| Dissolved | 15 - 18 mg/L | High DO - 20.0 mg/L |
| Oxygen | | Low DO - 8.0 mg/L |

### VI. INDUSTRIAL APPLICABILITY

The present invention relates to systems and methods for a plant growing environment that monitor and control both climate factors and hydroponic factors for optimum plant growth. Further, the growing environment may be a smart room or module, in which the monitoring and controlling of one or more factors may be via a wireless network.

Although only certain embodiments of the invention have been illustrated in the foregoing specification, it is understood by those skilled in the art that many modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in a generic and descriptive sense, and not for the purposes of limiting the description of the invention.

1. A system for growing plants, comprising:
a water circulation system connecting a plurality of deep water culture tanks in series and/or in parallel through which water is provided to plants housed in said tanks;
a nanobubble generator for oxygenating the water; and
a water cooling and disinfecting apparatus.

2. A system according to claim 1, wherein said water cooling and disinfecting apparatus comprises:
a plurality of coils through which a chilled liquid is circulated;
an inlet for oxygenated water from the nanobubble generator;
a passageway through which cooled oxygenated water is directed; and
at least one UV light that provides UV light to the cooled oxygenated water.

3. A system according to claim 2, wherein the passageway has an electropolished surface.

4. A system according to claim 2, wherein the passageway has a mirrored surface.

5. A system according to claim 1, further comprising:
at least one pH sensor to monitor pH of the water in the water circulation system;
at least one electroconductivity sensor to monitor nutrient level in the water; and
at least one sensor to monitor dissolved oxygen in the water.

6. The system according to claim 1, further comprising a grow light support system comprising a moveable support frame having:
a plurality of lights;
at least one carbon dioxide injection system;
at least one CO₂ sensor; and
at least one of a temperature sensor or humidity sensor.

7. The system according to claim 1, further comprising a heating, ventilation, and air conditioning (HVAC) system.

8. A plant growing environment, comprising:
a module or room comprising a system for growing plants as claimed in claim 1;
a grow light support system comprising a moveable support frame having a plurality of lights and at least one carbon dioxide injection system; and
a wireless network for providing hydroponic variables and climate variables monitored in the module to a device.

9. The plant growing environment according to claim 8, further comprising a heating, ventilation, and air conditioning (HVAC) system having condenser coils located outside of the module or room.

10. The plant growing environment according to claim 8, wherein the module or room has two or more zones, each zone comprising one or more deep water culture tanks and one or more grow light support systems.

11. A method for growing plants in a system having a water circulation system connecting a plurality of deep water culture tanks in series and/or in parallel through which water is provided to plants housed in said tanks; a nanobubble generator for oxygenating the water; and a water cooling and disinfecting apparatus, said method comprising:
oxygenating water in the water circulation system with oxygen nanobubbles from the nanobubble generator;
cooling and disinfecting the oxygenated water; and
providing the cooled and disinfected oxygenated water to the plurality of deep water culture tanks housing plants.

12. A method according to claim 11, comprising:
cooling oxygenated water by a plurality of coils through which a chilled liquid is circulated;
directing the cooled oxygenated water through a passageway having an electropolished or mirrored surface; and
exposing the cooled water to UV light, thereby disinfecting the cooled water.

13. A method according to claim 11, further comprising adding nutrients for the plants to the water before or after said oxygenating.

14. A method according to claim 11, further comprising replacing a water volume in the plurality of deep water culture tanks every 5 to 12 days.

15. A method according to claim 11, further comprising monitoring a level of oxygen in the water and electrical conductivity of the water.

16. A method according to claim 11, wherein the plants comprise cannabis or hemp.

17. A method according to claim 11, wherein no soil is used and wherein no natural light is provided to the plants.

18. A method according to claim 11, further comprising recycling water from the deep water culture tanks.

19. A water cooling and disinfecting apparatus, comprising:
a plurality of coils through which a chilled liquid is circulated;
an inlet for oxygenated water, configured such that said oxygenated water contacts said plurality of coils;
a passageway having an electropolished or mirrored surface through which the oxygenated water is directed;
at least one UV light that provides UV light to the oxygenated water, thereby disinfecting the oxygenated water; and
an outlet for the oxygenated water.

20. An apparatus according to claim 19, wherein the at least one UV light is located at an entry of the passageway.
